(19) United States
(12) Patent Application Publication
(10) Pub. No.: US 2017/0077474 A1
(43) Pub. Date: Mar. 16, 2017

(54) SEPARATOR OF LITHIUM ION BATTERY AND MANUFACTURING METHOD THEREOF, AND LITHIUM ION BATTERY

(71) Applicant: National Tsing Hua University, Hsinchu City (TW)

(72) Inventors: Ying-Ling Liu, Hsinchu City (TW); Hsieh-Yu Li, Hsinchu City (TW)

(21) Appl. No.: 14/965,884

(22) Filed: Dec. 10, 2015

(30) Foreign Application Priority Data
Sep. 10, 2015 (TW) 104129898

(51) Int. Cl. H01M 2/16; H01M 2/14; B29C 47/00; H01M 10/0525

(52) U.S. Cl. CPC H01M 2/162; H01M 10/0525; H01M 2/145; B29C 47/0014; H01M 2220/30; B29L 2031/3468

(57) ABSTRACT

A separator of lithium ion battery and manufacturing method thereof, and a lithium ion battery are provided. The separator of lithium ion battery is a thin film formed by thermal crosslinking of PBz (polybenzoxazine) electrospun fibers. This separator of lithium ion battery has properties of high ion conductivity, small N_{M} number, good thermal and dimensional stability, and high compatibility with liquid electrolyte.

### CROSS-REFERENCE TO RELATED APPLICATION

This application claims the priority benefit of Taiwan application no. 104129898, filed on Sep. 10, 2015. The entirety of the above-mentioned patent application is hereby incorporated by reference herein and made a part of this specification.

### BACKGROUND OF THE INVENTION

Field of the Invention

The present invention relates to a technique about a separator of lithium ion battery. More particularly, the present invention relates to a separator of lithium ion battery and a manufacturing method thereof, and a lithium ion battery.

Description of Related Art

Lithium ion battery, due to advantages of high energy density, high operating voltage, low self-discharge rate and long storage life, has became a battery system that has gained a lot of attention in recent years and is widely used in portable electronic application products.

A separator is one of important components of the lithium ion battery, and the separator in the market is mainly made of polyolefin at present. However, the polyolefin separator has the properties of low wettability, low porosity and low melting point, and undergoes a phenomenon of dramatically thermal deformation at 140° C., such that the development of the polyolefin separator is restricted. A method of adding nanoparticles or performing surface modification is employed to improve the thermal stability of the polyolefin separator. In addition, cellulose nanofiber paper is recently developed for the application of separators, however, the separator of such material has been found that is not suitable for batteries of high charge-discharge rate.

Therefore, one of the key points in research and development of this field is to seek other polymer materials, which are suitable for the application of the separator.

### SUMMARY OF THE INVENTION

The invention provides a separator of a lithium ion battery satisfying the characteristics of high ion conductivity, small N_{M} number, good thermal and dimensional stability, and high compatibility with liquid electrolyte.

The invention also provides a lithium ion battery which shows high charge-discharge rate capacity (C-rate capacity) and good cycle retention in a battery test.

The invention further provides a manufacturing method of a separator of a lithium ion battery, and which is capable of producing the separator having properties of high ion conductivity, small N_{M} number, good thermal and dimensional stability, and high compatibility with liquid electrolyte.

The separator of the lithium ion battery of the invention is a thin film consisting of thermally crosslinked polybenzoxazine (PBz) electrospun fibers.

In an embodiment of the invention, a number average molecular weight of polybenzoxazine in the thermally crosslinked PBz electrospun fibers is at least 5000 g/mol.

The lithium ion battery of the invention at least includes a cathode, an anode, an electrolyte and a separator located between the cathode and the anode, and the separator includes the aforementioned separator of the lithium ion battery.

The manufacturing method of a separator of a lithium ion battery includes the steps of forming PBz electrospun fibers by an electrospinning process, thermally crosslinking the PBz electrospun fibers, and pressing the thermally crosslinked PBz electrospun fibers to form the separator of lithium ion battery.

In an embodiment of the invention, raw materials of the PBz electrospun fibers include bisphenol A, formaldehyde, and 4,4′-diaminodiphenylether.

In an embodiment of the invention, a number average molecular weight of polybenzoxazine of the PBz electrospun fibers is at least 5000 g/mol.

In an embodiment of the invention, the thermal crosslinking is performed through a ring-opening addition reaction of benzoxazine groups.

Based on the above, in the invention, according to thermal crosslinking of the polybenzoxazine (PBz) electrospun fibers formed by an electrospinning process, the thin film is then obtained by pressing the thermally crosslinked PBz electrospun fibers. Since the thin film exhibits superior results in ion conductivity, N_{M} number, thermal and dimensional stability, and compatibility with liquid electrolyte, it is suitable for the separator of the lithium ion battery. Moreover, in consideration of the raw material prices, the raw materials for preparing polybenzoxazine in the invention further have advantages in manufacturing cost compared to other known thermally stable polymer for fabricating separator.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic view of a separator of a lithium ion battery according to one embodiment of the invention.

FIG. 2 shows steps of manufacturing a separator of a lithium ion battery according to another embodiment of the invention.

FIG. 3 is a scanning electron microscope (SEM) image of a separator of a lithium ion battery obtained in an experimental example.

FIG. 4 is a linear sweep voltammetric diagram of the separators of the experimental example and a comparative example 1.

FIG. 5 is a Nyquist plot of electrochemical impedance spectroscopy of the separators of the experimental example and the comparative example 1.

FIG. 6 is a graph showing capacity curves of half cells respectively using the separator of the experimental example and the separator of the comparative example 1 under different charge-discharge rates.

FIG. 7 is a graph showing a capacity curve of a half cell using the separator of the experimental example with a charge-discharge cycle test at 0.2 C.

FIG. 8 is a graph of a differential scanning calorimetry (DSC) of the separators of experimental example and the comparative examples 1-2.

FIG. 9 is a thermogravimetric analysis (TGA) diagram of the separators of the experimental example and the comparative example 1.

FIG. 10 is a schematic view of a lithium ion battery according to yet another embodiment of the invention.

### DESCRIPTION OF THE EMBODIMENTS

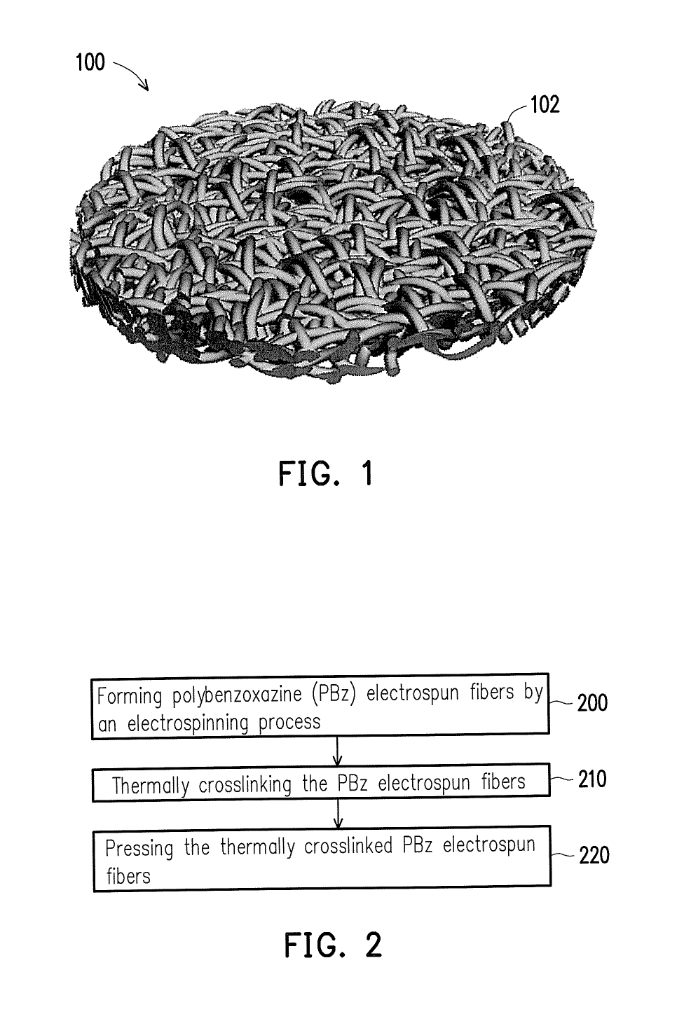

FIG. 1 is a schematic view of a separator of a lithium ion battery according to one embodiment of the invention.

In FIG. 1, a separator of a lithium ion battery of the present embodiment includes a thin film 100 consisting of thermally crosslinked polybenzoxazine (PBz) electrospun fibers 102. Since linear polybenzoxazine possess thermally-crosslinkable benzoxazine groups at the main chain, the thermally crosslinked PBz electrospun fibers is capable of showing high mechanical strength, high thermal stability, good film formability and flexibility, and hydrogen-boding ability. Also, according to subsequential experimental results, it is found that while the thin film 100 consisting of thermally crosslinked PBz electrospun fibers 102 is treated as the separator of the lithium ion battery, remarkable characteristics of the thin film 100 are shown, which includes high ion conductivity, small N_{M} number, good thermal and dimensional stability, and high compatibility with liquid electrolyte.

In the present embodiment, the thermally crosslinked PBz electrospun fibers 102, for example, have a mean diameter of 1.0 μm to 1.9 μm; however the invention is not limited thereto, dimensions of the thermally crosslinked PBz electrospun fibers 102 may be modified based on design needs. Similarly, dimensions of pore diameter and thickness of the thin film 100 can also be modified according to the needs of the lithium ion battery.

Since the thermally crosslinked PBz electrospun fibers 102 of the present embodiment are thermal crosslinkable, the separator of the lithium ion battery does not undergo the thermal deformation under high temperature. Further, as confirmed by experiments, the thin film 100 has a thermal shrinkage of 0%, at 150° C. after 0.5 hour.

FIG. 2 shows steps of manufacturing a separator of a lithium ion battery according to another embodiment of the invention.

Please referring to FIG. 2, in step 200, the polybenzoxazine (PBz) electrospun fibers is formed by an electrospinning process. Polybenzoxazine is prepared with inexpensive raw materials, such as bisphenol A, formaldehyde, and 4,4′-diaminodiphenylether. Hence, the raw materials of polybenzoxazine show the advantage in terms of cost, compared to other known thermally-stable polymer for fabrication of separator. The electrospinning process may adopt a solvent system for obtaining a solution used in the electrospinning process, wherein a range of solution concentration in the electrospinning process is, for example, about 20%-30% (w/v); however it is not limited thereto. Moreover, the solvent system, for example, includes tetrahydrofuran (THF) and dimethyl sulfoxide (DMSO), and a ratio of THF to DMSO can be 4:1 to 2:1, for example, 4:1, 3:1, or 2:1. According to a gel permeation chromatography (GPC) method, a number average molecular weight of polybenzoxazine of the PBz electrospun fibers is, for example, at least 5000 g/mol.

In step 210, the polybenzoxazine (PBz) electrospun fibers are thermally crosslinked, and which the thermal crosslinking of the polybenzoxazine (PBz) electrospun fibers is performed through a ring-opening addition reaction of benzoxazine groups. A process of the thermal crosslinking includes steps of, for example, placing the PBz electrospun fibers at room temperature for 1-3 days, then gradually increasing temperature at rates of 60° C./1 hour, 100° C./1 hour, 160° C./1 hour, 200° C./1 hour and 240° C./1-8 hours, to enhance the mechanical strength of the PBz electrospun fibers via thermal crosslinking. However, the above temperature and duration of the thermal crosslinking process is not intended to limit the process of the embodiment but for exemplary illustration.

In step 220, the thermally crosslinked PBz electrospun fibers are pressed to form the separator of the lithium ion battery. Accordingly, a flatter and finer thin film may be obtained for the separator of the lithium ion battery.

Several experimental examples are provided hereinafter for verification the effects of the invention, but the scope of the invention is not limited thereto.

### EXPERIMENTAL EXAMPLE

Bisphenol A, formaldehyde and 4,4′-diaminodiphenylether are used as raw materials to prepare a solution together with a solvent system of tetrahydrofuran (THF) and dimethyl sulfoxide (DMSO), where the mixing ratio of THF to DMSO is about 3:1 (v/v). The chemical structure of the prepared polybenzoxazine (PBz) is shown as follow:

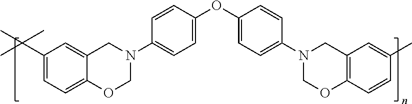

In the above chemical structure, n can be determined by molecular weight. For an exemplary, the polybenzoxazine obtained in the experimental example has a number average molecular weight of 6700 g/mol (polydispersity index: 2.80).

The electrospinning process is performed with conditions as follows: a solution concentration of 28 wt %, a solution flowing rate of 1.5 mL/h, a working voltage of 8.5 kV and a working distance of 15 cm, and the electrospun linear polybenzoxazine fibers obtained by the electrospinning process has a mean diameter of about 1.0 μm. Then, through a ring-opening addition reaction of benzoxazine groups, the polybenzoxazine electrospun fibers are thermally crosslinked. Subsequently, the thermally crosslinked PBz electrospun fibers are mechanically pressed at 1 MPa for one minute, to form the separator of the lithium ion battery. By measurements, the separator has a thickness of about 80 μm, a porosity of about 76%, and a mean pore size of about 4.0 μm.

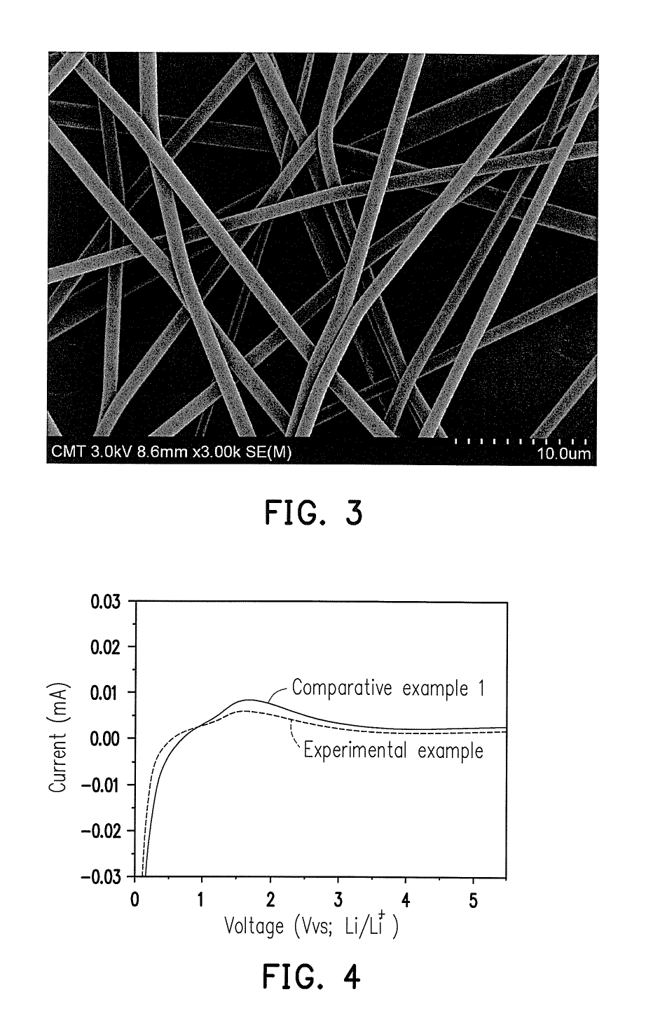

FIG. 3 is a scanning electron microscope (SEM) image of a separator of a lithium ion battery obtained in an experimental example, and which reveals that a mean dimension of the thermally crosslinked PBz electrospun fibers is about 1.0 μm. FIG. 3 shows the dimension of the thermally crosslinked PBz electrospun fibers maintains the same as the dimension of the PBz electrospun fibers before thermal crosslinking, and the appearance thereof has no significant change.

### Comparative Example 1

A Celgard® 2300 membrane manufactured by Celgard, LLC is used as the separator of the comparative example 1.

Electrochemical Analysis

Firstly, a linear sweep voltammetric diagram of the separators of the experimental example and the comparative example 1 is obtained, as shown in FIG. 4.

It can be observed from FIG. 4 that the separator of the experimental example has no significant component decomposition occurring till 5.5 V vs Li/Li⁺, which indicates the separator of the experimental example has electro-chemical stability. The electro-chemical stability of the separator of the experimental example is fully comparable to the data record with the comparative example 1, and which demonstrates the separator of the invention is suitable for the applications of a high voltage lithium ion battery.

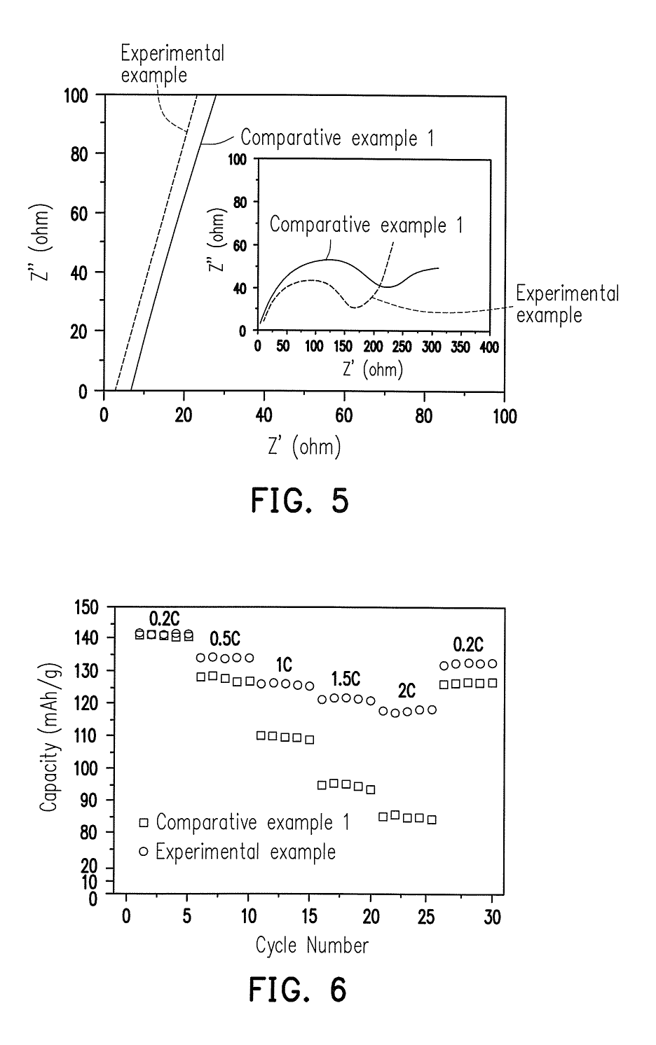

Furthermore, a Nyquist plot of the separator of the experimental example and the separator of the comparative example 1 is recorded with an electrochemical impedance spectrometry (EIS), and the results are shown in FIG. 5. An inserted figure in FIG. 5 reveals a Nyquist plot of a cell unit using the separators. This analyzed cell unit is a CR2032 coin-type cell with LiCoO₂ powders as the anode and a liquid electrolyte, wherein the liquid electrolyte contains 1.0 M LiPF₆ in EC/DMC (ethylene carbonate/dimethyl carbonate) (1/1, v/v).

According to FIG. 5, the experimental example has a lower resistance relative to that of the comparative example 1. The calculated ion conductivity is 2.92 mS cm⁻¹ for the separator of the experimental example, which is 5.2-fold of the value recorded on the comparative example 1. Therefore, the separator of the experimental example has a relatively low bulk resistance for Li-ion transportation through the separator. The feature also results in a relatively low charge-transfer resistance (R_{ct}) of Li-ion migration between the electrode and electrolyte interface in the cell unit employed the separator of the experimental example. From the inserted figure of FIG. 5, the charge-transfer resistance (165Ω) of the experimental example is significantly lower than the charge-transfer resistance (225Ω) measured with Celgard 2300.

Moreover, a rated capacity test of the cell units using the separators of the experimental example and the comparative example 1 is performed, and the results are shown in FIG. 6. According to FIG. 6, both half-cells employed the separators of the experimental example and the comparative example 1 exhibit similar voltage profile and capacity (about 141 mAh/g) at 0.2 C. Nevertheless, at higher C-rates, the half-cell employed the separator of the experimental example demonstrates a significant improvement in battery performance. In detail, the capacity of the half-cell employed the separator of the comparative example 1 is 110 mAh/g at 1.0 C and 85 mAh/g at 2.0 C, which indicates that the capacity thereof obviously drops at higher C-rates. Yet, the capacity of the half-cell employed the separator of the experimental example is 126 mAh/g at 1.0 C and 118 mAh/g at 2.0 C. Accordingly, at 2.0 C, the half-cell employed the separator of the experimental example only exhibits a 16% loss of capacity, compared to a 40% loss of capacity found with the comparative example 1. Moreover, the half-cell using the separator of the experimental example still maintains a good cycling stability at 0.2 C.

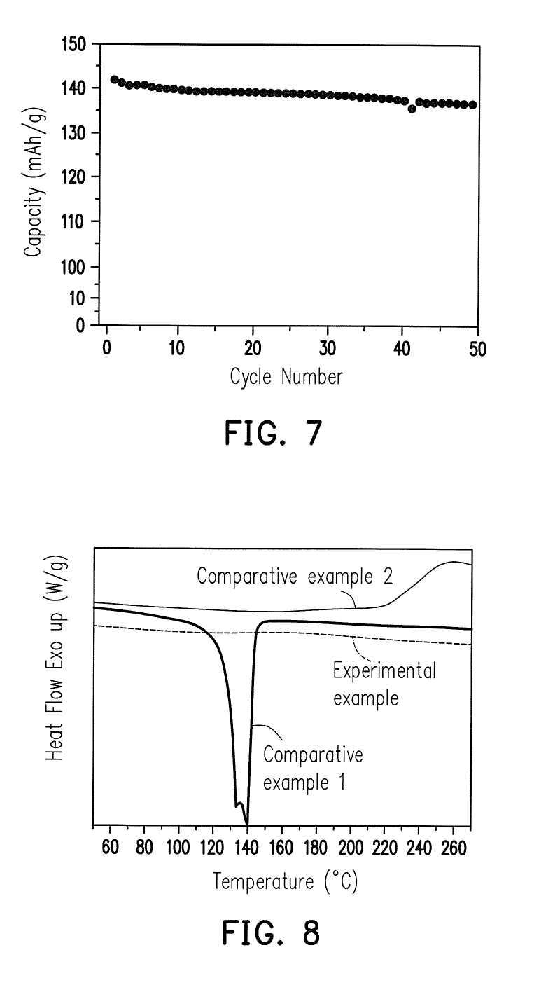

FIG. 7 is a graph showing a capacity curve of a half cell using the separator of the experimental example with a charge-discharge cycle test at 0.2 C. According to FIG. 7, after 50 charge-discharge cycles, a recovered discharge capacity is about 136.6 mAh/g, corresponding to only a 3.1% loss of capacity. Therefore, such result indicates that the separator of the experimental example is a high performance separator for high capacity lithium ion batteries.

Interface Compatibility Test

The liquid electrolyte is respectively supplied onto the surface of the separator of the experimental example and the separator of the comparative example 1. By observation, the droplet of the liquid electrolyte sinks into the separator of the experimental example quickly, but the droplet of the liquid electrolyte stands well on the separator of the comparative example 1 with a contact angle of about 57°. Therefore, the separator of the experimental example has a high compatibility with the liquid electrolyte, and it is presumed to be one reason why the separator of the experimental example has surprisingly high ion conductivity.

Besides, an immersion-height test of the separators of the experimental example and the comparative example 1 is performed. In the immersion-height test, one end of the separator of the experimental example is immersed in the liquid electrolyte, and after one minute, it is observed that the separator of the experimental example is wetted with a height of about 17 mm, compared to the height of 3 mm recorded with the separator of the comparative example 1. Similar to the other known separators (such as cellulose, poly-amide, polybenzoxazole, etc.) having thermal stability, polar groups (—OH and tertiary amines) of the separator of the experimental example are beneficial to enhance the compatibility between the separator and the electrolyte. Further, an interaction between the separator of the experimental example and the electrolyte is likely to be hydrogen-bonding. Polybenzoxazine is known to tend to form inter- and intra-chain hydrogen bonding, so as to be able to form hydrogen bonding with the electrolyte components through the —OH groups of the separator of the experimental example.

Compared with the 115% uptake of the separator of the comparative example 1, due to the separator of the experimental example has high compatibility and wettability with the electrolyte, accompanied with the high porosity and the interconnected pore structure, the separator of the experimental example of the invention has a ultrahigh electrolyte uptake (about 825%). Due to the separator having such high wettability and uptake, it may help the liquid electrolyte being transported to the cell unit, which is beneficial for high capacity electrodes and batteries of automobiles and other applications.

Besides, according to the high ion conductivity, the separator of the experimental example has a MacMüllin number (N_{M}) of about 3.35, i.e. a ratio of the ion conductivity of the liquid electrolyte-filled separator over that (9.8 mS cm⁻¹) of the liquid electrolyte. Compared with the MacMüllin number (N_{M}=4.5-10) of other non-woven separator and the MacMüllin number (N_{M}=17.46) of the separator of the comparative example 1, the MacMüllin number of the separator of the experimental example is relatively low.

The low value of N_{M} number of the separator of the experimental example can be attributed to the promotion of the battery's rated capacity. Such property is supported by the result of FIG. 6.

Moreover, in some studies, an overall evaluation of a separator/electrolyte resistance is obtained by using a N_{M}l factor, where “l” represents a thickness (in a unit of μm) of a separator, refer to Patel, K. K., Paulsen, J. M, and Desilvestro, J., (2003), J. Power Sources, 122, pages 144-152. Also, some studies further point out a conclusion that the N_{M}l factor is a related indicator of a separator having high C rates, see Dijin, D., Alloin, F., Martinet, S., Lignier, H. and Sanchez, J. Y, (2007), J. Power Sources, 172, pages 416-421. Therefore, in the invention, the N_{M}l factor calculated for the separator of the experimental example is about 268 μm, which is lower than the N_{M}l factor (437 μm) of the separator of the comparative example 1. Since the N_{M}l factor of the separator of the experimental example is close to the optimized value of about 280 μm in the above studies, it demonstrates that the thermally crosslinked PBz electrospun fibers could fall in the category of high C-rate separators.

Evaluation of Mechanical Property

The mechanical property of the separator of the experimental example is evaluated by using instron machine for applying a tensile strength of about 10 MPa. The mechanical property of the separator of the experimental example is close to that of other electrospun polyamide-based separators having thermal stability.

### Comparative Example 2

To compare with the experimental example, a separator of the comparative example 2 is formed by adopting the same manufacturing method of the experimental example, but no thermal crosslinking process is performed.

Thermal Analysis

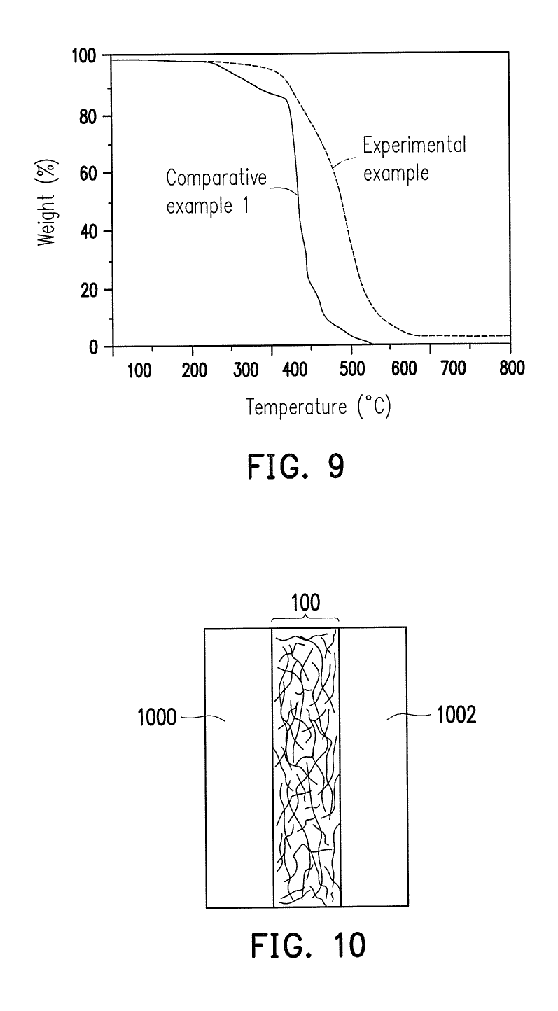

A differential scanning calorimetric analysis is respectively performed on the separators of the experimental example, the comparative example 1, and the comparative example 2; and the results are shown in FIG. 8. Furthermore, a thermogravimetric analysis is respectively performed on the separators of the experimental example and the comparative example 1; and the results are shown in FIG. 9.

According to FIG. 8, in a temperature interval of 60° C. to 260° C., the separator of the experimental example reveals neither endothermic (melting) nor exothermic (decomposition) changes. Regarding a change in the appearance of the separators, at 150° C. for 0.5 hour, the separator of the experimental example shows almost zero thermal shrinkage, and the separator of the comparative example 1 has a thermal shrinkage of about 60%. This is because the separator of the comparative example 1 and the separators of polyolefin are likely affected by high temperature and then melting; however, the separator of the invention is thermally crosslinked, thus the separator of the invention will not melt in a heating process.

Furthermore, about only 2% and 10% dimensional changes are observed with the separator of the experimental example at 300° C. for 1 hour and at 350° C. for 1 hour. The results demonstrate superior thermal stability and nonshutdown characteristic of the separator of the experimental example.

From the above results of the experimental analyses, the thin film of the invention formed by thermally crosslinking of polybenzoxazine (PBz) electrospun fibers as the separator, indeed, exhibits superior performances in various characteristics.

FIG. 10 is a schematic view of a lithium ion battery according to yet another embodiment of the invention.

In FIG. 10, the lithium ion battery at least includes a cathode 1000, an anode 1002, an electrolyte, and a thin film 100 as a separator between the cathode 1000 and the anode 1002. However, the invention is not limited thereto, any lithium ion battery technology currently used, which is suitable to the invention, can be adopted.

Based on the above, in the invention, the thin film formed by thermally crosslinking of polybenzoxazine (PBz) electrospun fibers is adopted as the separator of the lithium ion battery so as to improve the properties of ion conductivity, N_{M} number, thermal and dimensional stability, and compatibility with liquid electrolyte.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A separator of a lithium ion battery, comprising a thin film consisting of thermally crosslinked polybenzoxazine (PBz) electrospun fibers.

2. The separator of the lithium ion battery as claimed in claim 1, wherein a number average molecular weight of polybenzoxazine in the thermally crosslinked PBz electrospun fibers is at least 5000 g/mol.

3. A lithium ion battery, at least comprising a cathode, an anode, an electrolyte and a separator located between the cathode and the anode, wherein the separator is the separator of the lithium ion battery as claimed in claim 1.

4. A lithium ion battery, at least comprising a cathode, an anode, an electrolyte and a separator located between the cathode and the anode, wherein the separator is the separator of the lithium ion battery as claimed in claim 2.

5. A manufacturing method of a separator of a lithium ion battery, comprising:
forming polybenzoxazine (PBz) electrospun fibers by an electrospinning process;
thermally crosslinking the PBz electrospun fibers; and
pressing the thermally crosslinked PBz electrospun fibers for forming the separator of the lithium ion battery.

6. The manufacturing method of the separator of the lithium ion battery as claimed in claim 5, wherein raw materials of the PBz electrospun fibers comprises bisphenol A, formaldehyde and 4,4′-diaminodiphenylether.

7. The manufacturing method of the separator of the lithium ion battery as claimed in claim 5, wherein a number average molecular weight of polybenzoxazine of the PBz electrospun fibers is at least 5000 g/mol.

8. The manufacturing method of the separator of the lithium ion battery as claimed in claim 5, wherein the thermal crosslinking is performed through a ring-opening addition reaction of benzoxazine groups.
